(19) United States
(12) Patent Application Publication
(10) Pub. No.: US 2004/0210432 A1
(43) Pub. Date: Oct. 21, 2004

(54) Simulation apparatus and method for storing operation information

(75) Inventor: Naoya Kamiyama, Hyogo (JP)

Correspondence Address: OLIFF & BERRIDGE, PLC, P.O. BOX 19928, ALEXANDRIA, VA, 22320, US

(73) Assignee: FUJITSU TEN LIMITED, Kobe-shi (JP)

(21) Appl. No.: 10/692,807

(22) Filed: Oct. 27, 2003

(30) Foreign Application Priority Data
Oct. 25, 2002 (JP) 2002-310479

(51) Int. Cl. G06F 17/50

(52) U.S. Cl. 703/17

(57) ABSTRACT

A simulation apparatus includes a data setting section, a data output section, a storage section and an event data storage section. The data setting section allows a user to set first data. The data output section supplies a control target with second data created based on the first data. When setting operation of the first data through the data setting section is detected, the event data storage section stores as event data into the storage section, a time when the setting operation is performed; a value of the data at that time; and information about the data.

The present disclosure relates to the subject matter contained in Japanese Application No. 2002-310479 filed on Oct. 25, 2002, which is incorporated herein by reference in its entirety.

### BACKGROUND OF THE INVENTION

1. Field of the Invention

The present invention relates to a simulation apparatus and a method for storing operation information, and particularly relates to a simulation apparatus and a method for storing operation information in which information about operation for setting data to be transmitted to a control target during execution of simulation can be stored.

2. Description of the Related Art

In the related art, in order to efficiently design and evaluate an electronic control apparatus or the like for controlling a vehicle engine, various measurements of operating conditions are not carried out with the electronic control apparatus being connected to a real controlled apparatus such as a vehicle, but behavior of the controlled apparatus is simulated by use of a simulation apparatus (that is, arithmetic operation is carried out using a vehicle model expressed by numerical formulas).

Some simulation apparatus is equipped with a function for storing information about operation for setting data to be output to a control target during execution of simulation. JP-B-Hei.8-27589 discloses that the process of operation carried out actually by an operator using a computer of an operator training simulator, and the process of changes of process values of pressure, flow rate, and so on, in accordance with the operation are recorded in time series into a save disk as operator's operation information.

However, in the operator training simulator disclosed in JP-B-Hei.8-27589, the operator's operation information is recorded in time series from a recording start time. Therefore, for example, on the assumption that the recording period is 1 msec, the amount of data to be acquired in one measuring period is 256 bytes, and the recording time is 5 minutes, a disk capacity of about 7.3 Mbytes for the 5 minutes is required. In such a manner, when the operation information is recorded in time series, the recorded data amount increases dependently on the recording period or the recording time. Thus, there is a problem that when the recording period is short or when the recording time is long, a sufficient memory space and a large disk capacity corresponding thereto are required.

### SUMMARY OF THE INVENTION

The present invention was developed in consideration of the problem. It is an object of the invention to provide a simulation apparatus and a method for storing operation information, in which the amount of data to be stored can be reduced on a large scale so that the load in processing for storing data can be lightened, and memory means for storing the data can be used efficiently.

In order to attain the object, a simulation apparatus (1) according to the invention includes an output data setting section, a data output section, a storage section, an event data storage section. The output data setting section sets data, which is output to a control target during execution of simulation. The data output section supplies the control target with output data created on the basis of the data set through the output data setting section. When setting operation of the data through the output data setting section is detected, the event data storage section stores into the storage section as event data: a time when the setting operation is carried out; a value of the data at the time; and information about the data.

In the simulation apparatus (1), the time when the setting operation is carried out, the value of the data at that time, and the information about that data are stored into the storage section as event data when setting operation of data through the output data setting section is detected. That is, only data when the setting operation is performed is stored into the storage means as the event data. Accordingly, it is not necessary to always keep storing data in time series as in the related art. Thus, the load in processing for storing data can be lightened on a large scale, so that the storage section can be used efficiently. In addition, there is no fear that the amount of data increases in accordance with the storing period or the storing time as in the case where data is always stored continuously in time series. Accordingly, it is possible to reduce the storage capacity of the storage means. When the storage means has a fixed capacity, the time of storing data can be increased on a large scale.

A simulation apparatus (2) of the invention, further includes an event playback section for reading the event data stored in the storage section; supplying the control target with output data created on the basis of based on analysis of the event data; and playing back the setting operation indicated by the event data, in the simulation apparatus (1).

In the simulation apparatus (2), the event playback section can play back the setting operation based on the event data read from the storage section. Accordingly, processing for playing back the setting operation can be performed easily.

According to a simulation apparatus (3) of the invention, in the simulation apparatus (2), the event playback section starts playing back the setting operation at timing indicated by a user.

In the simulation apparatus (3), playback can be started at the timing indicated by the user. Accordingly, the playback of the setting operation can be performed at the timing intended by the user.

According to a simulation apparatus (4) of the invention, in the simulation apparatus (2), the event playback section starts playing back the setting operation automatically when predetermined data is detected.

In the simulation apparatus (4), playback is started automatically when the predetermined data is detected. Accordingly, it is possible to play back setting operation in association with the predetermined data.

A simulation apparatus (5) of the invention further includes a waiting time setting section for setting a waiting time till starting playing back the setting operation, in the simulation apparatus (2). The event playback section starts the playback when the waiting time set by the waiting time setting section has passed.

In the simulation apparatus (5), the user is allowed to set a desired waiting time through the waiting time setting section, for example, when the user wants to start playback when a predetermined time has passed or when a waiting time till start of playback is known beforehand. Accordingly, the event playback section can start playback when the set waiting time has passed.

A simulation apparatus (6) of the invention further includes a playback number setting section for setting number of repetition times according to which the event playback section play back the setting operation, in the simulation apparatus (2). The event playback section plays back the setting operation repeatedly the number of repetition times set by the playback number setting section.

In the simulation apparatus (6), the user is allowed to set a desired number of repetition times through the playback number setting section, for example, when the user wants to play back the setting operation repeatedly. Thus, the setting operation can be played back by the event playback section repeatedly the set number of repetition times.

A simulation apparatus (7) of the invention further includes an event data editing section for editing the event data stored in the storage section, in any one of the simulation apparatus (1) to (6).

In the simulation apparatus (7), the event data stored in the storage section can be edited into data desired by the user in accordance with necessity. Accordingly, simulation using more proper data can be executed.

According to simulation apparatus (8) of the invention, in the simulation apparatus (7), the event data editing section includes a signal waveform editing section for editing the read event data into a predetermined signal waveform. The signal waveform editing section includes a signal waveform registration section for registering the event data edited through the signal waveform editing section as signal waveform data.

In the simulation apparatus (8), the event data can be edited into the signal waveform through signal waveform editing section. In addition, the edited event data can be registered as the signal waveform data. Accordingly, the event data registered as the signal waveform data in advance can be used during execution of simulation.

A simulation apparatus (9) of the invention further includes an event data editing section for editing the event data stored in the storage section, in any one of the simulation apparatus (2) to (6).

In the simulation apparatus (9), the event data stored in the storage section can be edited into data desired by the user in accordance with necessity. Accordingly, simulation using more proper data can be executed.

According to simulation apparatus (10) of the invention, in the simulation apparatus (9), the event data editing section includes a text data editing section for editing the read event data into predetermined data. The event playback section plays back the setting operation indicated by the event data edited through the text data editing section.

In the simulation apparatus (10), the event data, for example, the time or the value of data at that time can be edited into desired data easily through the text data editing section using text display. In addition, the event playback section can play back the setting operation indicated by the edited event data.

According to a operation information storage method (1) of the invention stores a time when the setting operation is carried out; a value of the data at the time; and information about the data, as event data when setting operation of the data through the output data setting section is detected.

In the operation information storage method (1) the time when the setting operation is carried out, the value of the data at that time, and the information about that data are stored as the event data when setting operation of data through the data setting section is detected. That is, only data when the setting operation is carried out is stored as the event data. Accordingly, it is not necessary to always keep storing data in time series as in the related art. Thus, the load in processing for storing data can be lightened on a large scale so that the storage means can be used efficiently. In addition, there is no fear that the amount of data increases in accordance with the storing period or the storing time as in the case where data is always stored continuously in time series. Accordingly, it is possible to reduce the storage capacity of the storage section. When the storage section has a fixed capacity, the time of storing data can be increased on a large scale.

### BRIEF DESCRIPTION OF THE DRAWINGS

FIG. 1 is a block diagram schematically showing a main portion of a simulation apparatus according to an embodiment of the invention.

FIG. 2 is a diagram showing an example of display of a simulation execution operation screen to be displayed on a display.

FIG. 3 is a view showing an example of display of a C-panel screen to be displayed on the display.

FIG. 4 is a view showing an example of display of an operation information storage setting screen to be displayed on the display.

FIG. 5 is a table showing a data structure of event data to be stored in a RAM.

FIG. 6 is a view showing an example of display of a screen to be displayed on the display when an operating button is operated on the operation information storage setting screen.

FIG. 7 is a flow chart showing a storage processing operation to be performed by a microcomputer in the simulation apparatus according to the embodiment.

FIG. 8 is a flow chart showing a playback processing operation to be performed by the microcomputer in the simulation apparatus according to the embodiment.

FIG. 9 is a flow chart showing an edition processing operation to be performed by the microcomputer in the simulation apparatus according to the embodiment.

### DETAILED DESCRIPTION OF THE PREFERRED EMBODIMENT

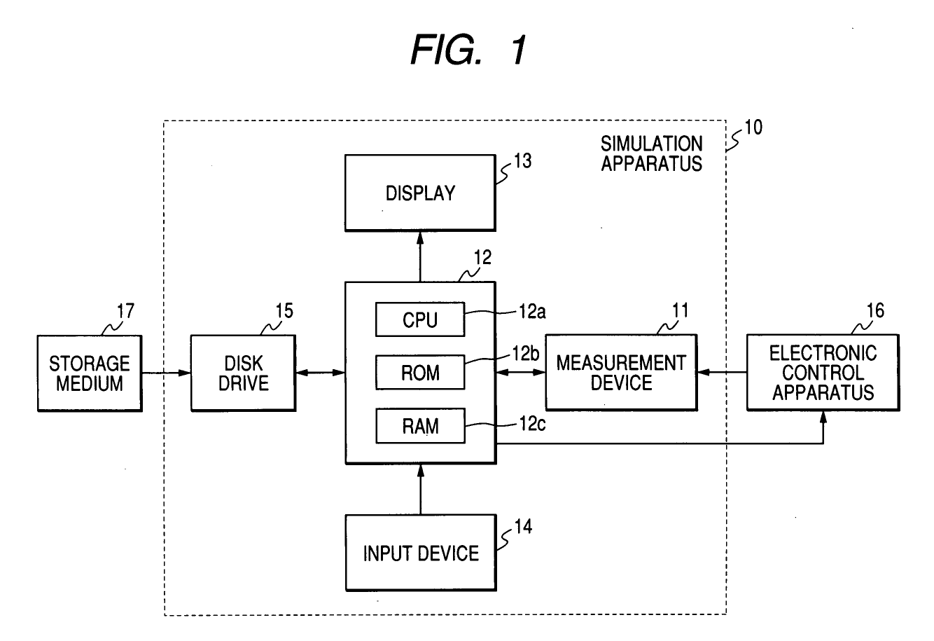

An embodiment of a simulation apparatus and a method for storing operation information according to the invention will be described below with reference to the drawings. FIG. 1 is a block diagram schematically showing a main portion of the simulation apparatus according to this embodiment.

A simulation apparatus 10 includes a measurement device 11, a microcomputer 12, a display 13, an input device 14 and a disk drive 15. An electronic control apparatus 16, which is a control target, is connected to the simulation apparatus 10.

The microcomputer 12 includes a CPU 12a, a ROM 12b and a RAM 12c. The ROM 12a stores an operating program for executing simulation. The CPU 12a reads the operating program, and performs various arithmetic processings for executing the simulation. Then, the CPU 12a performs processing such as storing results of the various arithmetic processings into the RAM 12c and outputting the results to the display 13, the measurement device 11 or the electronic control apparatus 16.

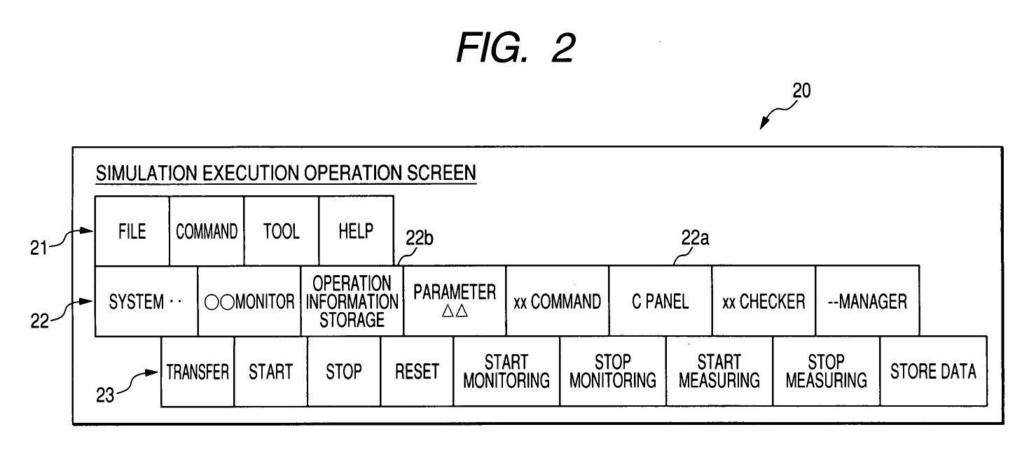

When a user operates the input device 14 having a keyboard or a mouse so as to perform an input operation on a simulation execution button displayed on the display 13 constituted by a CRT, a LCD, or the like, a simulation execution operation screen shown in FIG. 2 is displayed on the display 13.

The simulation execution operation screen 20 displays menu buttons 21 including “file”, “command”, “tool” and so on, a plurality of tool buttons 22 which can activate tools required for performing various settings to execute simulation, and command buttons 23 for performing various simulation operations. That is, the simulation execution operation screen 20 functions as a user interface during execution of the simulation.

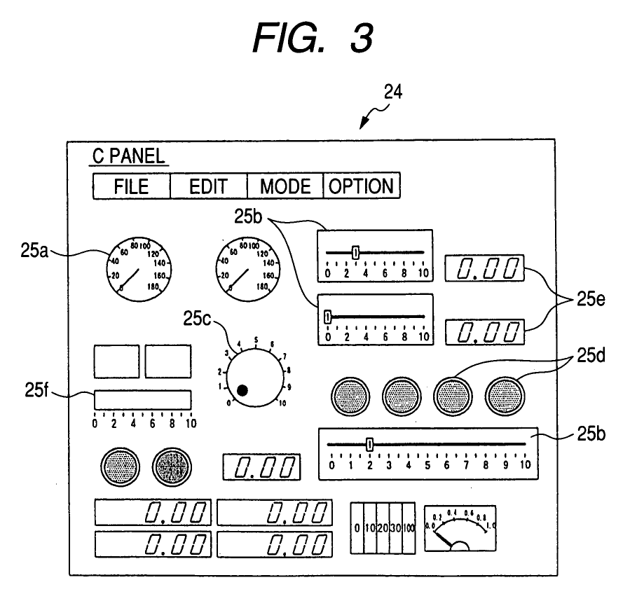

The tool buttons 22 include a control panel (hereinafter referred to as “C-panel”) display button 22a for setting various data to be output to the electronic control apparatus 16 during execution of simulation. FIG. 3 shows an example of display of a C-panel screen to be displayed on the display 13 when the C-panel display button 22a is operated.

The C-panel screen 24 is a tool having a function by which the user can construct a unique simulation execution screen. The user can place various control buttons 25 including meters 25a, sliders 25b, a rotary switch 25c, LED displays 25d, digital displays 25e, a bar display 25f, and so on, desirably on the C-panel screen 24. When the respective displays (the LED displays 25d, the digital displays 25e, the bar display 25f, and so on) are connected to data to be sampled, various data during execution of the simulation can be displayed on the C-panel screen 24 dialogically. In addition, the user can perform setting operation of various control buttons 25 (for example, the sliders 25b, the rotary switch 25c and so on) while referring to the display.

Various data, which is set through the C-panel screen 24 and is required for driving the electronic control apparatus 16, is supplied from the simulation apparatus 10 to the electronic control apparatus 16. In the electronic control apparatus 16, arithmetic processing is performed using the data supplied from the simulation apparatus 10, and various control signals are output to the measurement device 11 of the simulation apparatus 10.

The measurement device 11 performs a simulated calculation of the state quantity in each part of a vehicle model on the basis of various control signals sent from the electronic control apparatus 16 or various input components input through the C-panel screen 24 or the like. Then, the measurement device 11 supplies the operation results to the microcomputer 12. The microcomputer 12 estimates the operation status of a controlled instrument (such as an engine) on the basis of these data, and displays the estimation result on the display 13.

The user can set various data to be supplied to the electronic control apparatus 16, desirably through the C-panel screen 24 with reference to the operation status of the controlled instrument displayed on the display 13. In addition, the user can confirm the operation of the electronic control apparatus 16 or estimate the performance thereof by use of various data.

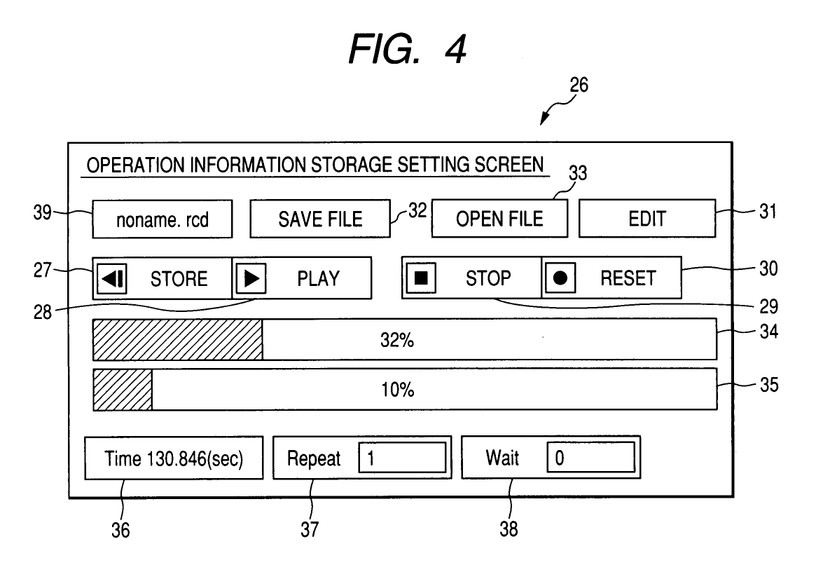

In addition, the tool buttons 22 shown in FIG. 2 include a display button 22b for displaying an operation information storage setting screen on the display 13. On the operation information storage setting screen, the user can give an instruction of processing for storing setting operation of each control button 25 allocated on the C-panel screen 24 shown in FIG. 3. FIG. 4 is a view showing an example of the operation information storage setting screen to be displayed on the display 13 when the button 22b is operated.

The operation information storage setting screen 26 is a tool for performing the following processing by way of example: to store the setting operation (also referred to as “event”) of various control buttons 25 such as the sliders 25b, the rotary switch 25c and so on allocated on the C-panel screen 24 shown in FIG. 3, into the RAM 12c or a storage medium 17 as event data; to play back setting operation indicated by the stored event data; and to edit the stored event data.

The operation information storage setting screen 26 includes buttons 27 to 33. The store button 27 is used to start processing for storing event data. The play button 28 is used to read the stored event data at desired timing indicated by the user, and to start processing for playing back the setting operation indicated by the event data. The stop button 29 is used to stop the storing processing when the storing processing is in progress, and stop the playback processing when the playback processing is in progress. The reset button 30 is used to delete the stored event data. The edit button 31 is used to perform various processings for editing the stored event data. The file save button 32 is used to give a file name to the stored event data and save it. The button 33 is used to read a predetermined file into a buffer.

Through a window 39, the user can specify a name of a file when the user wants to save the file, and specify a name of a file saved in the past when the user wants to play back or edit the file. In addition, the operation information storage setting screen 26 includes a buffer capacity display field 34 in which the buffer capacity for storing event data is displayed by bar; and a playback amount display field 35 in which the playback a mount after the play button 28 is operated is displayed by bar. Thus, the user can grasp the storage conditions or the playback conditions in real time.

In addition, the operation information storage setting screen 26 includes an event data storing time display field 36 in which the storing time for which event data has been stored is displayed; a repetition number setting field 37 through which the number of repetition times of playback can be set; and a waiting time setting field 38 through which the waiting time till the playback time can be set, in its lowest line.

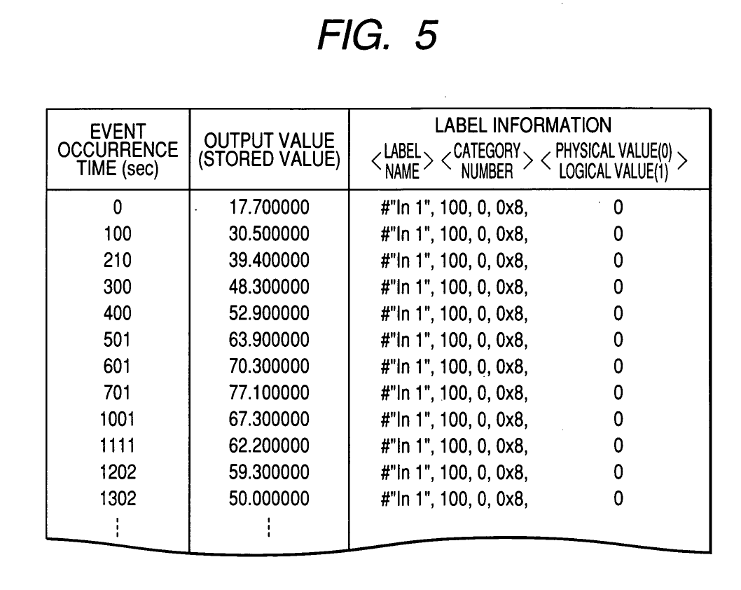

FIG. 5 is a table showing the data structure of the event data, which is stored in the RAM 12c when the store button 27 is operated on the operation information storage setting screen 26.

The event data includes a time value of event occurrence from start of the storing processing (the store button 27 was operated); an output value (stored value) of data at each time; and label information (a label name, category numbers, and a value indicating either a physical value or a logical value) about the data.

The category numbers include a board number indicating the number of a device, a port number in that board, and a channel number in that port. A label name corresponding to those category numbers is used. For example, the label name “In1”, the category numbers including the board number “100”, the port number “0” and the channel number “0×8”, and the value “0” indicating a physical value are stored in the label information about data at the time of 0 sec.

The event data stored in the RAM 12c may be saved in the storage medium 17 set in the disk drive 15.

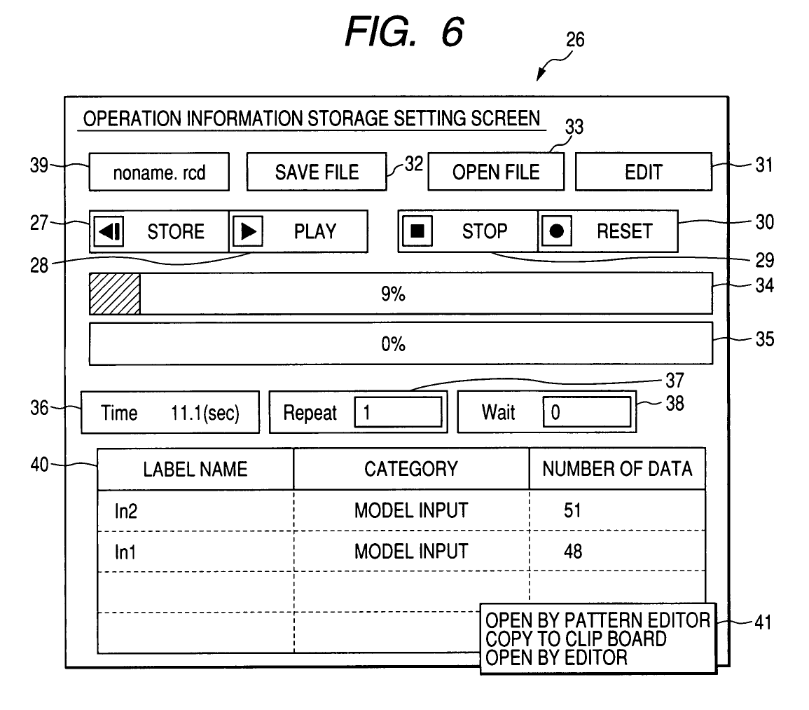

FIG. 6 is a view showing an example of the operation information storage setting screen, which is displayed when the edit button 31 is operated.

When the edit button 31 is operated, the label names of the event data stored in the RAM 12c are shown by a list (table 40). When a right click operation of the mouse is detected, a popup menu 41 is displayed. The popup menu 41 includes items “open by pattern editor”, “copy to clipboard” and “open by editor”.

For example, when the item “open by pattern editor” is selected from the menu, a pattern editor (application software), which can create a predetermined signal waveform, is started up. The user can edit the signal waveform created based on the data of label names shown by a list on the pattern editor. Then, the event data edited on the pattern editor can be registered as signal waveform data.

When the item “copy to clipboard” is selected from the menu, the time of the event data or the value of data at that time can be copied. Then, for example, the copied time or the copied value of data can be pasted onto another application software such as spreadsheet software.

When the item “open by editor” is selected from the menu, a text editor for displaying the data of label names shown by a list is started up. The user can edit the data (time or a data value at that time) of label names shown by a list, into a desired value on the text editor. The contents edited by the text editor are reflected on the playback of setting operation when the play button 28 is operated.

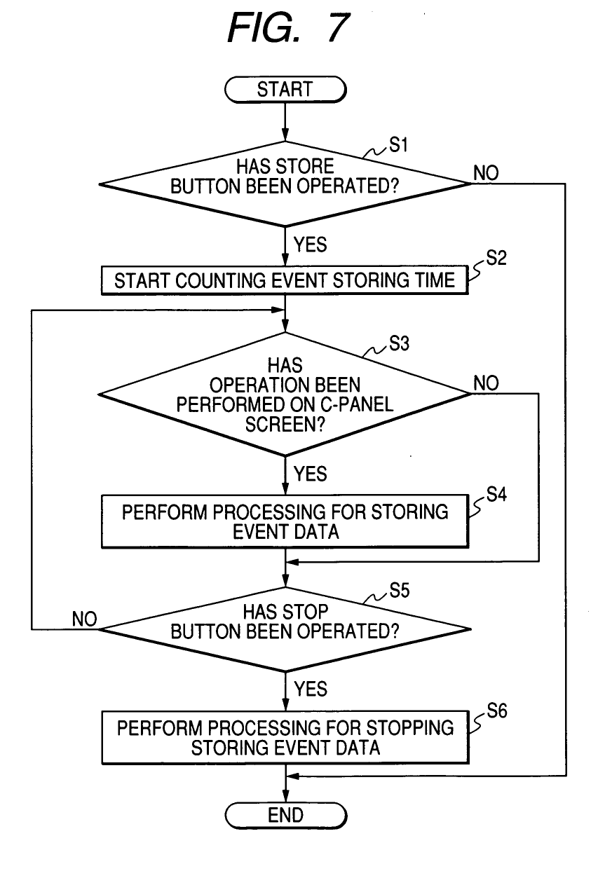

Next, the storing processing operation, which is performed by the microcomputer 12 of the simulation apparatus 10 according to the embodiment, will be described with reference to a flow chart shown in FIG. 7. Incidentally, this processing operation is executed after the C-panel screen 24 and the operation information storage setting screen 26 are displayed on the display 13.

First, in step S1, it is judged whether the store button 27 has been operated or not. The processing operation is terminated when it is concluded that the store button 27 has not been operated. On the contrary, the processing operation advances to step S2 when it is concluded that the store button 27 has been operated. In step S2, it is started to count the event storing time, and the processing operation advances to step S3.

In step S3, it is judged whether the various control buttons 25 such as the sliders 25b displayed on the C-panel screen 24 have been operated or not. The processing operation advances to step S4 when it is concluded that operation has been performed on the panel 24. In step S4, processing for storing event data, that is, processing for storing a time value of an event occurrence from the start of the storing processing, a value of data at that time, and label information (a label name, category numbers, and a physical/logical value) about that data into the RAM 12c is performed. After that, the processing operation advances to step S5. On the other hand, when it is concluded in step S3 that no operation has been performed on the C-panel screen 24, the processing operation skips to step S5.

In step S5, it is judged whether the stop button 29 has been operated or not. When it is concluded that the stop button 29 has not been operated, the processing operation returns to step S3. On the contrary, when it is concluded that the stop button 29 has been operated, the processing operation advances to step S6. In Step S6, processing for stopping storing the event data is performed. Then, the processing operation is terminated.

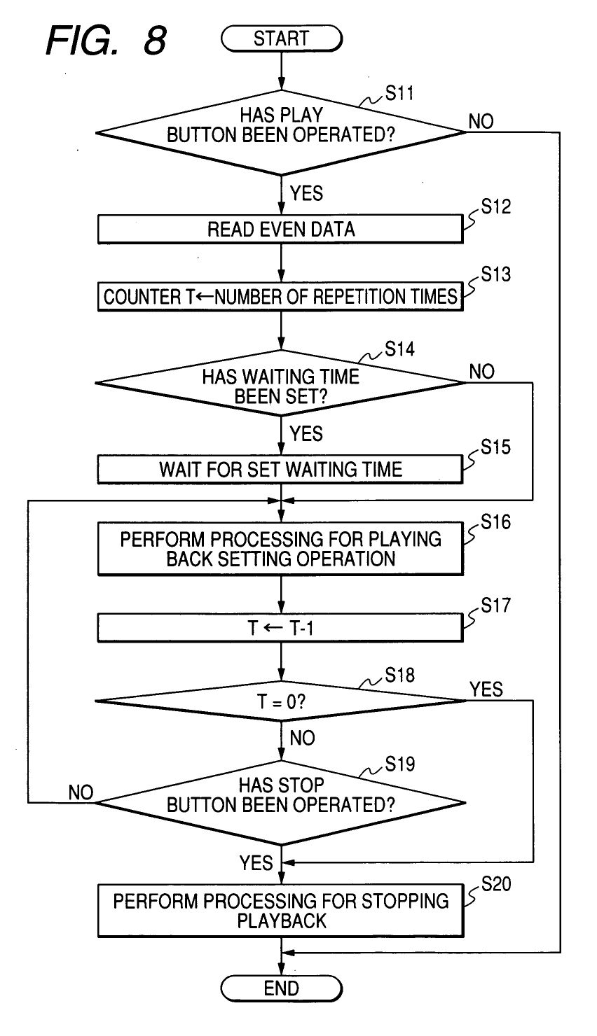

Next, the playback processing operation, which is performed by the microcomputer 12 of the simulation apparatus 10 according to the embodiment, will be described with reference to the flowchart shown in FIG. 8. Incidentally, this processing operation is executed after the storing processing operation has been executed.

First, in step S11, it is judged whether the play button 28 has been operated or not. When it is concluded that the play button 28 has been operated, the processing operation is terminated. On the other hand, when it is concluded that the play button 28 has been operated, the processing operation advances to step S12.

In step S12, the event data is read from the RAM 12c, and the processing operation advances to step S13. In step S13, the number of repetition times set in the repetition number setting field 37 is set into a counter T, and the processing operation advances to step S14. In step S14, it is judged whether a waiting time has been set or not. When it is concluded that no waiting time has been set, the processing operation skips to step S16. On the contrary, when it is concluded that a waiting time has been set, the processing operation advances to step S15.

In step S15, processing for waiting for the set waiting time is performed. Then, the processing operation advances to step S16. In step S16, processing for playing back setting operation indicated by the read event data, that is, processing for supplying the electronic control apparatus 16 as a control target with output data created based on the analysis of the read event data is performed. After that, the processing operation advances to step S17. In step S17, 1 is subtracted from the counter T in which the number of repetition times has been set. Then, the processing operation advances to step S18. In step S18, it is judged whether the counter T has reached 0 or not. When it is concluded that the counter T has reached 0, the processing operation skips to Step S20. On the contrary, when it is concluded in step S18 that the counter T has not reached 0, the processing operation advances to step S19.

In Step S19, it is judged whether the stop button 29 has been operated or not. When it is concluded that the stop button 29 has been operated, the processing operation returns to Step S16, to repeat the processing for playing back the event data. On the contrary, when it is concluded that the stop button 29 has been operated, the processing operation advances to step S20. In Step S20, processing for stopping playing back the setting operation indicated by the event data is performed. Then, the processing operation is terminated.

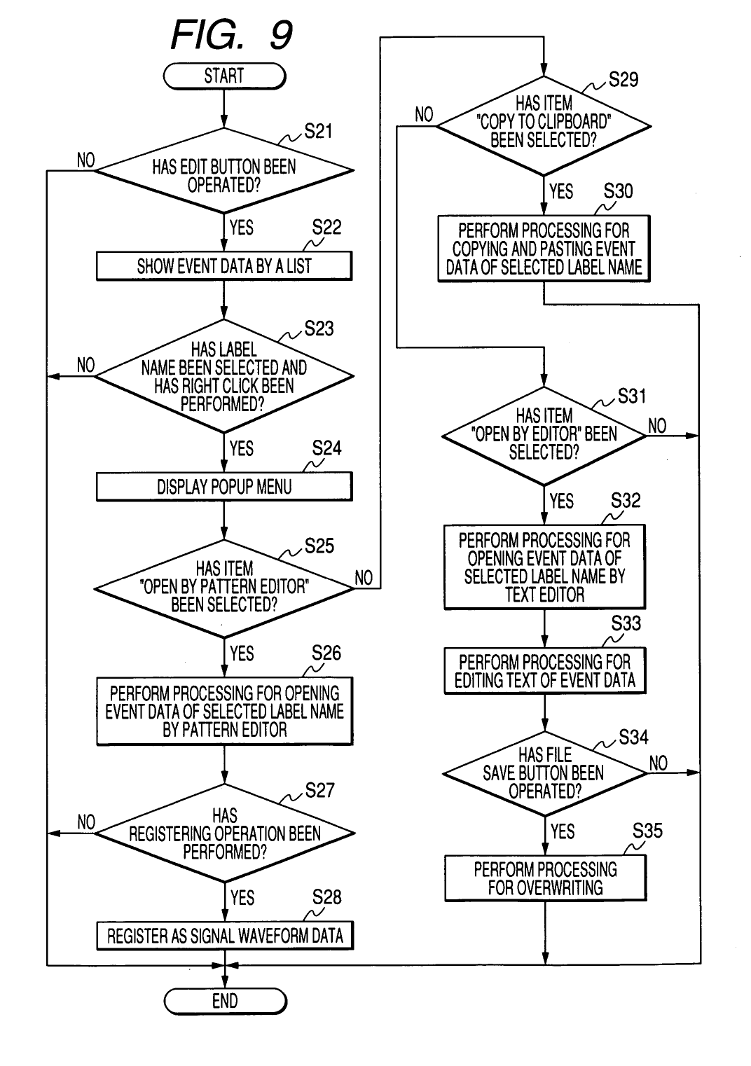

Next, the editing processing operation, which is performed by the microcomputer 12 of the simulation apparatus 10 according to the embodiment, will be described with reference to a flow chart shown in FIG. 9. Incidentally, this processing operation is executed after the storing processing operation has been executed.

First, in step S21, it is judged whether the edit button 31 has been operated or not. When it is concluded that the edit button 31 has been operated, the processing operation is terminated. On the contrary, when it is concluded that the edit button 31 has been operated, the processing operation advances to step S22.

In step S22, processing for showing label names of event data stored in the RAM 12c by a list is performed. After that, the processing operation advances to step S23. In step 23, it is judged whether a label name to be edited has been selected and a right click operation of the mouse has been performed or not. When it is concluded that no label name has been selected or no right click operation of the mouse has been performed, the processing operation is terminated. On the contrary, when it is concluded that a label name has been selected and a right click operation of the mouse has been performed, the processing operation advances to step S24.

In Step S24, processing for displaying the popup menu 41 on the label name list display screen 40 is performed. After that, the processing operation advances to step S25. In step S25, it is judged whether the item “open by pattern editor” has been selected or not. When it is concluded that the item “open by pattern editor” has been selected, the processing operation advances to step S26.

In step S26, processing for opening event data of the selected label name by a pattern editor is performed, so as to allow the user to edit the signal waveform formed of the event data. After that, the processing operation advances to step S27. In step S27, it is judged whether registering operation by the pattern editor has been performed or not. When it is concluded that registering operation has been performed, the processing operation advances to step S28. In step S28, the edited event data is registered as signal waveform data. On the contrary, when it is concluded in step S27 that no registering operation has been performed, the processing operation is terminated.

On the other hand, when it is concluded in step S25 that the item “open by pattern editor” has not been selected, the processing operation advances to step S29. In step S29, it is judged whether the item “copy to clipboard” has been selected or not. When it is concluded that the item “copy to clipboard” has been selected, the processing operation advances to step S30. In Step S30, processing for copying event data (text data) of the selected label name and pasting it to spreadsheet software or the like is performed. After that, the processing operation is terminated.

On the contrary, when it is concluded in step S29 that the item “copy to clipboard” has not been selected, the processing operation skips to step S31. In step S31, it is judged whether the item “open by editor” has been selected or not. When it is concluded that the item “open by editor” has not been selected, the processing operation is terminated. On the contrary, when it is concluded that the item “open by editor” has been selected, the processing operation advances to step S32.

In step S32, processing for opening the event data of the selected label name by a text editor is performed. After that, the processing operation advances to step S33. In Step S33, processing for editing the text of the event data is accepted and performed. After that, the processing operation advances to step S34. In step S34, it is judged whether the file save button 32 has been operated or not. When it is concluded that the file save button 32 has been operated, the processing operation advances to step S35. In step S35, processing for overwriting the event data is performed and then, the processing operation is terminated. On the contrary, when it is concluded in step S34 that the file save button 32 has not been operated, the processing operation is terminated.

According to the simulation apparatus 10 of the embodiment, in response to setting operation of data performed through the C-panel screen 24, the time when the operation was performed, the value of the data at that time, and the information about that data a restored into the RAM 12c as event data. Specifically, when operation of various control buttons 25 is detected, only data at a time when the operation of the various control buttons 25 was performed is stored as event data. It is not necessary to always keep storing data in time series as disclosed in the related art. Accordingly, the load in processing for storing data can be lightened on a large scale, so that the RAM 12c can be used efficiently. In addition, there is no fear that the data amount increases in accordance with the storing period or the storing time as in the case where data is always stored continuously in time series. Accordingly, the storage capacity of the RAM 12c can be reduced. When the RAM 12c has a fixed capacity, the data storing time can be increased on a large scale.

In addition, when the play button 28 is operated on the operation information storage setting screen 26, event data is read from the RAM 12c and setting operation of various control buttons 25 can be played back. That is, playback processing on the same operating conditions can be reproduced easily. In addition, the playback can be started at desired timing by the play button 28. Accordingly, operation of various control buttons 25 can be played back at timing intended by the user.

In addition, the waiting time setting field 38 is provided on the operation information storage setting screen 26. A desired waiting time can be input and set in the waiting time setting field 38. Thus, playback of event data can be started after the set waiting time has passed.

In addition, the repetition number setting field 37 is provided on the operation information storage setting screen 26. A desired number of repetition times can be input and set in the repetition number setting field 37. Thus, event data can be played back repeatedly the set number of repetition times.

In addition, event data stored in the RAM 12c can be edited into data desired by the user through the edit button 31 on the operation information storage setting screen 26. For example, event data can be edited into a desired signal waveform by a pattern editor. In addition, the edited event data can be registered as signal waveform data. Thus, event data registered as signal waveform data in advance can be used during execution of simulation.

In addition, event data (time or a value of data at that time) can be easily edited into predetermined data using text display through an editor. In addition, setting operation indicated by the edited event data can be played back.

Incidentally, in the embodiment, playback can be started at desired timing by the play button 28 on the operation information storage setting screen 26. In another embodiment, however, setting operation indicated by event data may be started automatically in response to detection of predetermined data. According to the configuration of such an embodiment, playback is started automatically in response to detection of predetermined data. Accordingly, it is possible to play back setting operation in association with the predetermined data.

What is claimed is:

1. A simulation apparatus comprising:
an output data setting section for setting data, which is output to a control target during execution of simulation;
a data output section for supplying the control target with output data created on the basis of the data set through the output data setting section;
a storage section; and
an event data storage section for storing into the storage section as event data:
a time when the setting operation is carried out;
a value of the data at the time; and
information about the data,
when setting operation of the data through the output data setting section is detected.

2. The simulation apparatus according to claim 1, further comprising:
an event playback section for:
reading the event data stored in the storage section;
supplying the control target with output data created on the basis of based on analysis of the event data; and
playing back the setting operation indicated by the event data.

3. The simulation apparatus according to claim 2, wherein the event playback section starts playing back the setting operation at timing indicated by a user.

4. The simulation apparatus according to claim 2, wherein the event playback section starts playing back the setting operation automatically when predetermined data is detected.

5. The simulation apparatus according to claim 2, further comprising:
a waiting time setting section for setting a waiting time till starting playing back the setting operation,
wherein the event playback section starts the playback when the waiting time set by the waiting time setting section has passed.

6. The simulation apparatus according to claim 2, further comprising:
a playback number setting section for setting number of repetition times according to which the event playback section play back the setting operation,
wherein the event playback section plays back the setting operation repeatedly the number of repetition times set by the playback number setting section.

7. The simulation apparatus according to claim 1, further comprising:
an event data editing section for editing the event data stored in the storage section.

8. The simulation apparatus according to claim 7, wherein:
the event data editing section includes a signal waveform editing section for editing the read event data into a predetermined signal waveform; and
the signal waveform editing section includes a signal waveform registration section for registering the event data edited through the signal waveform editing section as signal waveform data.

9. The simulation apparatus according to claim 2, further comprising:
an event data editing section for editing the event data stored in the storage section.

10. The simulation apparatus according to claim 9, wherein:
the event data editing section includes a text data editing section for editing the read event data into predetermined data; and
the event playback section plays back the setting operation indicated by the event data edited through the text data editing section.

11. An operation information storage method for storing information of data subjected to setting operation through a data setting section for setting data, which is output to a control target during execution of simulation, the method comprising storing:
a time when the setting operation is carried out;
a value of the data at the time; and
information about the data,
as event data when setting operation of the data through the output data setting section is detected.

12. A simulation apparatus comprising:
a data setting section for allowing a user to set first data;
a data output section for supplying a control target with second data created based on the first data;
a storage section; and
an event data storage section for storing into the storage section as event data:
a time when the setting operation is carried out;
a value of the data at the time; and
information about the data,
when setting operation of the data through the data setting section is detected.

13. An operation information storage method comprising storing:
a time when the setting operation is carried out;
a value of the data at the time; and
information about the data,
as event data when setting operation of the data, which is output to a control target, through a data setting section is detected.
